(19) United States
(12) Patent Application Publication
(10) Pub. No.: US 2003/0097659 A1
(43) Pub. Date: May 22, 2003

(54) Interrupting the output of media content in response to an event

(76) Inventor: Phillip Y. Goldman, Los Altos, CA (US)

Correspondence Address: WORKMAN NYDEGGER & SEELEY, 1000 EAGLE GATE TOWER, 60 EAST SOUTH TEMPLE, SALT LAKE CITY, UT, 84111, US

(21) Appl. No.: 09/993,795

(22) Filed: Nov. 16, 2001

(51) Int. Cl. H04N 7/173; H04N 7/16

(52) U.S. Cl. 725/89; 725/141; 725/142; 725/134

(57) ABSTRACT

Responding to an event in the environment of a computing device by pausing the display of a television program. After detecting an event that indicates that the viewing experience of a viewer is likely to have been interrupted, a computing device automatically pauses the output of the television program and begins recording a television signal on which the television program is encoded. When the interruption is completed, the recorded television signal is resumed in a time-shifted manner such that the viewer can continue viewing without missing the portion of the television program that would have otherwise been displayed during the interruption. In this manner, the television program can be automatically paused in response to events that may interrupt the viewing experience, such as an incoming telephone call, the receipt of an electronic message, or other events occurring in the home or in the environment of the computing device.

### BACKGROUND OF THE INVENTION

1. The Field of the Invention

The present invention pertains to the field of streaming media. More particularly, the present invention relates to an interruption engine, which may use a customizable set of rules, to facilitate the performance of an action on a stream of media content in response to a detected event.

2. Background and Related Art

During recent years, a large number of new television services and features have been made available to television viewers to enhance the television viewing experience. For instance, cable and satellite television systems have greatly increased the number of television programs available to viewers. Video cassette recorders and, more recently, digital video recording systems enable viewers to record a program at the time of broadcast and to view the recorded program at a later time.

Such video recording systems are most useful when the viewer has advance notice that a television program is to be recorded. For example, conventional video recording systems are well suited for situations in which the viewer is to be away from home at the time of broadcast. In this situation, the viewer can program the video recording system to record the desired program at the time of broadcast. Many video recording systems also enable viewers to watch one television program while recording another. In either of these situations, the video recording system can be successfully used to record a television program when the viewer has advance notice that the television program cannot be viewed at the time of the original broadcast.

A more recent innovation in video recording systems is pausing a live broadcast of a television program. Pausing a live broadcast generally involves the viewer providing user input, such as from a remote control device, which causes the video recording system to record video data associated with the television program in a buffer. At such time that the viewer wishes to resume viewing the television program, the viewer provides additional user input, causing the recorded video data to be displayed on the television in a first-in-first-out manner from the buffer. As the video data from the buffer is displayed on the television, more video data associated with the television program continues to be received and recorded to the buffer. The result is a time-shifting of the live broadcast of the television program, which appears to the viewer as if the broadcast of the television program were actually paused and resumed in response to the user input.

Pausing a live broadcast of a television program in this manner is particularly useful when the viewer wishes to take a break from television viewing for a few minutes, to watch another television program using another tuner, or to engage in some other activity. In any of these cases, the television program is paused in response to an affirmative decision by the viewer and accompanying input from the user that signals that the pause is to be initiated. While pausing can significantly enhance the viewing experience, there are many times that a pause is desired when the viewer does not have sufficient time or inclination to physically manipulate the remote control device to initiate the pause. Such situations arise when an event in the home requires immediate attention from the viewer and may not permit the viewer to find and interact with the remote control device. Examples of such events include an incoming telephone calls, ringing doorbells, and the like. Viewers using conventional video recording systems typically forego pausing the television program in order to give immediate attention to such events, resulting in a diminished viewing experience.

### SUMMARY OF THE INVENTION

The present invention relates to systems that automatically perform an operation on media content in response to detecting an event that indicates the operation on the media content is to be performed. Although the invention can be used to automatically perform substantially any desired operation, the invention will be described herein primarily in the context of an interruption operation that includes pausing the output of the media content, such as a television program. Thus, when the system detects the event, the pause of the television program is initiated. At a later time, either in response to user input or in response to the detection of another event, a subsequent operation, such as resuming the display of the paused television program, can be performed. In this manner, the output or display of the television program or other media content can be automatically paused in response to an event that requires the immediate attention of the viewer without requiring the viewer to physically provide user input to the video recording system.

In operation, a computing device, such as a set-top box, television, personal computer, or mobile device, receives and outputs media content. Types of media content include broadcast video, streaming video, media from compact discs or digital versatile discs, audio, animation, or other streaming media. Media content, such as the foregoing, is output to a display device and/or speakers. During preparation for output and output of the media content, the computing device detects an event that indicates an operation is to be performed on the media content. Such an operation may include interrupting the output of the media content, sending media content to a recording device, or muting the output of media content. Such events that may indicate an operation is to be performed include an incoming telephone call, a ringing telephone, a telephone in an “off hook” state, a call waiting signal or any other event that indicates that a telephone call is being made or received. The events that can be detected by the invention are not limited to those associated with telephone calls, but can be any detectable event that could result in an interruption of the viewing experience. Examples of other such events include the receipt of an instant message or electronic mail message or a signal from another device, such as a transmitter or motion detector.

In response to detecting an event indicative of an interruption, media content prepared for output after the event is detected is automatically stored so as to initiate the pause operation. This may include storing the media content to a mass storage device such as a magnetic hard disk. In response to detecting a subsequent event that indicates that the interruption operation is to be terminated, the recorded multimedia content is output in a time-shifted manner and the portion of the media content that was recorded during the interruption is displayed. In response to detecting an event indicative of muting the output of media content, output to audio output devices may be stopped or the volume may be reduced to an inaudible level.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

The present invention is illustrated by way of example and not limitation in the figures of the accompanying drawings, in which like references indicate similar elements and in which:

FIG. 1 illustrates an exemplary network system that provides a suitable operating environment for the present invention.

FIG. 2 illustrates an exemplary system that provides a suitable operating environment for the present invention.

FIG. 3 is a flow diagram illustrating a method for automatically time shifting the output of media content in response to the detection of an event.

FIG. 4 is a flow diagram illustrating a method for using rules to automatically time shift the output of media content in response to the detection of an event having an assigned priority value.

### DETAILED DESCRIPTION OF THE PREFERRED EMBODIMENTS

The present invention relates to systems that automatically perform an operation on media content in response to detecting an event that indicates an operation that modifies the output of media content is to be performed. In general, the modification of the output of the media content is interrupted or otherwise modified in a way such that the output of the media content can be later resumed or otherwise restored. As used herein, the term “media content” extends to, but is not limited to, television programming, streaming video, streaming audio, video or audio data provided from a medium on which it is recorded, such as a compact disc or video versatile disc, other video or audio, animation, moving images, combinations of the foregoing, and the like. Although any such media content can be used in combination with the invention, the invention will be described herein primarily in terms of television programming for purposes of illustration. The term “television programming” extends to video data and can also include the associated audio data.

Although the invention can be used to automatically perform substantially any desired operation, the invention will be described herein primarily in the context of an interruption operation that includes pausing the display of the media content, such as a television program. Thus, when the event is detected, the pause of the television program is initiated. At a later time, either in response to user input or in response to the detection of another event, a subsequent operation, such as resuming the display of the paused television program, can be performed. In this manner, the output or display of the television program or other media content can be automatically paused in response to an event that requires the immediate attention of the viewer without requiring the viewer to physically provide user input to the video recording system.

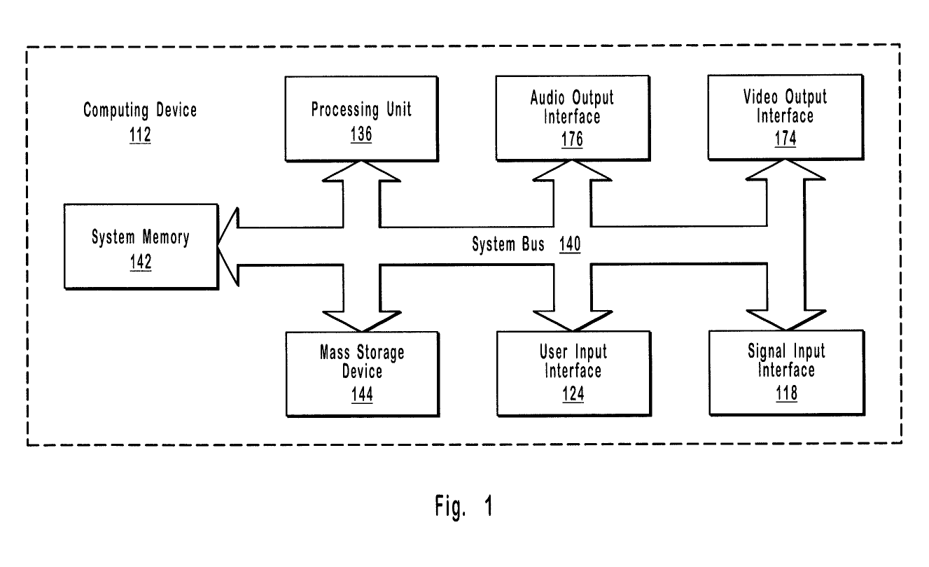

FIG. 1 illustrates one example of a network environment in which the methods of the invention can be practiced. Client system 110 includes a computing device 112 that obtains a television signal that represents a television program that is displayed on display device 114, which is a conventional television or any other display device on which the television program can be displayed. The manner in which the client system obtains the television signal or other media content depends on the source of the content. For instance, the media content can be obtained as it is received from a broadcast source. If, however, the media content is stored locally on a DVD, the media content is obtained by reading the media content from the medium on which it is stored.

Display device 114 and speakers 116 represent examples of output devices by which media content is output. Computing device 112 may be a set-top box or other computing device that has been adapted to perform the operations disclosed herein. Computer device 112 can be integrally positioned with or separate from display device 114. Computing device 112 detects the occurrence of an event in client system 110 or in another portion of the network environment of FIG. 1 that indicates that the output of the media content is to be modified. In this example, the output of the media content is modified by interrupting the display of the television program on display device 114.

In one embodiment, a general-purpose interruption engine included in computing device 112 detects the events and initiates the interruption operations. For purposes of this description and in the claims, the term “interruption engine” is defined as a hardware module, software module, or combination of both that causes an interruption operation to occur in response to receiving information that indicates output of media content is to be interrupted.

While the interruption engine of computing device 112 can detect substantially any event that is designated as one that indicates that the display of a television program on display device 114 is to be interrupted, FIG. 1 illustrates several types of events that can be detected. In this illustrated embodiment, computing device 112 shares communication link 122 with other devices included in FIG. 1. Accordingly, communication link 122 may be used for both data communication (by client system 110, client system 120, and computing device 146) and voice communication at different times. In addition, communication link 122 enables computing device 112 to monitor events in the environment of computing device 112 to identify the occurrence of an event that indicates that the display of the television program is to be interrupted. Communication link 122 may be a standard telephone line or other connection that enables data and voice transmission. For example, a connection to a cable service provider that enables transmission of voice over Internet Protocol, television programming, and Internet access.

The events detected by computing device 112 can include those that are associated with the telephone aspects of communication link 122. For example, computing device 112 can detect events on a telephone line, such as a ring signal, an off-hook state of telephone 145, an off-hook state of the telephone immediately after a ring signal, a call waiting signal, or other events that vary the electrical characteristics of the telephone line or that indicate that a telephone call is being made or received. For example, telephone 145 being in the off-hook position can be designated as an event, such that when computing device 112 may detect this event, the interruption operation is initiated.

The events can arise in other portions of the environment of computing device 112, such as devices included in home network 150, or other devices 155, including motion sensor 156 and/or personal transmitter 157. While home network 150 enables substantially any event to be detected in the environment of computing device 112, events that are particularly useful to detect include those that tend to be associated with an interruption in the viewing experience by the viewer. One example of such an event is the ringing of a doorbell, which tends to be associated with television viewers leaving the viewing area to greet a visitor. Computing device 112 may also detect software events. Such events may include detecting the state of a software object or the state of a property of a software object. Computing device 112 may detect software events in external modules such as a web browser or electronic mail program.

Home network 150 may be a home automation network that includes one or more home automation modules. These modules automate the use of home appliances or other household devices, such as lights, thermostats, or sprinkler systems. Communication between devices included in a home automation network may be facilitated by protocols that function over existing electrical wiring, such as the X-10 protocol. In these embodiments, computing device 112 is configured to communicate with home network 150 using such protocols.

Motion sensor 156 and personal transmitter 157, when used with the invention, transmit information to computing device 112 when the viewer has left the viewing area associated with client system 110. It should be understood that the present invention is not limited to detection of events from these locations. It would be apparent to one skilled in the art, in view of the disclosure made herein, that a wide variety of events may be detected in order to implement the principles of the present invention.

An incoming electronic message, such as electronic mail, received by any electronic component of the environment of computing device 112 represents another example of an event that can be designated as one that indicates that the display of the television program is to be interrupted. For example, computing device 112, computing device 146, and electronic components associated with 150 and 120 can be capable of receiving electronic messages that result in computing device 112 pausing or otherwise interrupting the display of the television program. Pausing may be based on the attributes of an electronic message, such as the sender of the message or the importance assigned to the message. Electronic messages may be broadcast messages that are sent synchronously or asynchronously in media content that is being received from an external location, for example, multimedia transport system 160.

Computing device 112 may also receive information from other devices included in network 170, for example, multimedia transport system 160, telephone 161, mobile telephone, 162 or computing device 163. For example, computing device 112 may receive an instant message from the user of mobile telephone 162 or information associated with television programming from multimedia transport system 160. These events can be designated as events that are to result in the interruption of the display of a television program.

In the foregoing examples, the computing device uses any of a variety of input mechanisms by which interrupt sources inform the computing device that certain events have occurred. Moreover, in the foregoing examples, the interruption engine of computing device 112 recognizes that the events indicate that the display of the television program is to be interrupted. In response, the interruption engine initiates the interruption operation, one example of which is a pause of the live broadcast of the television program. Detection of events and the associated execution of the interruption operation are performed automatically in the sense that the viewer is not required to provide specific user input requesting the pause operation or other interruption operation. This process is particularly useful in situations where the event is one that may demand the attention of the viewer such that the viewer cannot continue viewing the television program.

If, for instance, the event is a telephone ring signal associated with an incoming telephone call, computing device 112 recognizes this event as one that indicates that the display of the television program is to be paused or otherwise interrupted. Thus, when telephone 145 begins to ring, the television program being viewed by the viewer is automatically paused without requiring the viewer to affirmatively decide to pause the television program and to manipulate remote control device 126 to provide user input requesting the pause. Instead, the viewer can immediately give attention to the incoming telephone call with the assurance that the television program can be resumed after the telephone call is completed.

If the event is an off-hook state of telephone 145, computing device 112 recognizes this event as one that indicates that the display of the television program is to be paused or otherwise interrupted. Thus, when telephone 145 is taken off-hook, the television program being viewed by the viewer is automatically paused without requiring the viewer to affirmatively decide to pause the television program and to manipulate remote control device 126 to provide user input requesting the pause. Recognizing the off-hook state as an event provides the benefit of pausing the display of the television program if the viewer decides to answer an incoming call or place an incoming call rather than immediately pausing the display of the television program as soon as the telephone begins to ring.

As noted above, the invention extends to substantially any interruption operation that is performed in order to compensate for an interruption in the viewing experience of the viewer in response to an event. One interruption operation that is particularly well-suited to compensate for an interruption in the viewing experience is pausing the display of television programming. When the television programming is from a broadcast source, the pause operation involves time-shifting the display of the television programming such that, from the standpoint of the viewer, it appears as if the broadcast of the television programming were paused. When the media content is obtained from a medium on which the content is recorded, such as a CD or DVD, pausing the media content involves delaying the process of reading and rendering the content. It may be also appropriate to perform other actions that modify the output of the media content, either singly or in combination with pausing the display of televising programming, such as sending the television programming to an external recording device or muting audio portions of the output.

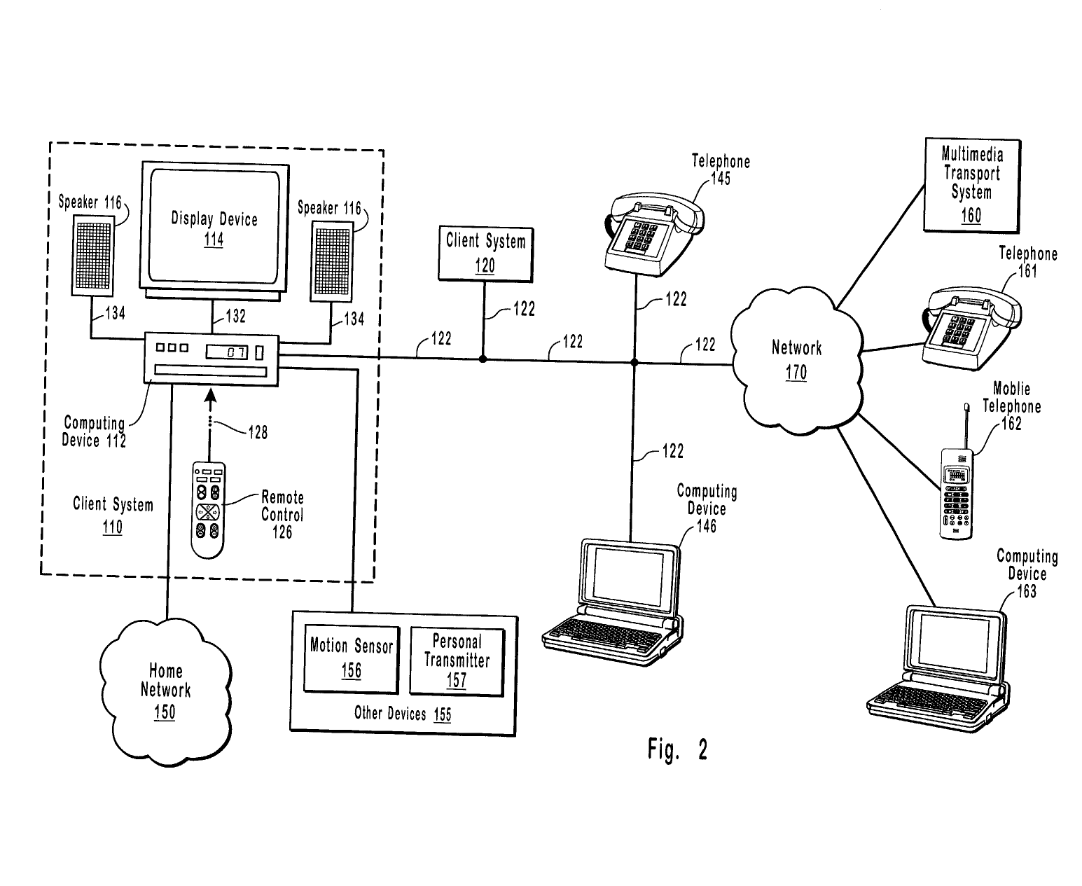

FIG. 2 illustrates components of one embodiment of computing device 112 in greater detail, including those that are used to perform the pause operation. Computing device 112 includes a television signal input interface 118 that receives a television signal in which the television program is encoded. Television signal input interface 118 receives television signals from a cable television network included in network 170 via communication link 122, from a satellite, from a terrestrial antenna, or in any other way. When the television program is displayed, the audio portion is output through audio output interface 176, while the video portion is output through video output interface 174.

The operation of computing device 112 is controlled by a processing unit 136, which uses computer-executable instructions implemented in software and/or hardwired logic circuitry. Processing unit 136 is coupled to other components included in computing device 112 via system bus 140. System bus 140 also interconnects various other system components, such as the system memory 142, mass storage interface 144, user interface 124 and signal input 118. Processing unit 136 executes software designed to implement features of computing device 112 including features of the present invention. Instructions, data, and other software necessary for the operation of processing unit 136 may be stored in system memory 142, such as in read-only memory (“ROM”) and/or in random-access memory (“RAM”), and/or in mass storage device 144. ROM, RAM, and mass storage device 144 are communicatively coupled to processing unit 136 so as to be readable by processing unit 136 and so that data may be written from processing unit 136 to RAM and mass storage device 144.

Mass storage device 144 may be a magnetic hard disk or any other magnetic or optical mass memory device that is capable of storing large amounts of data. Any desired computer-readable instructions or data, including application programs or other program modules, may be stored in mass storage device 144.

When computing device 112 detects an event as described herein, the pause operation is initiated by storing the television signal in a digital format, such as the Moving Pictures Experts Group (MPEG) format, on mass storage device 144. Thus, the portion of the television program that would otherwise be displayed to the viewer after the event is recorded to mass storage device 144 such that it can be time-shifted and displayed to the viewer after the interruption in the viewing experience associated with the detected event is completed.

So long as the incoming television program is being recorded to mass storage device 144 so that it can be later displayed in a time-shifted manner, the image, or lack thereof, displayed on display device 114 of FIG. 1 during the pause is not critical to the invention. For example, pausing the television program may include terminating the display of any image on display device 114 or continually refreshing the last image displayed on display device 114 prior to the pause operation so as to make the image appear still. Additionally, pausing the display of the television program may include terminating the output of audio data to speakers 116 of FIG. 1.

Alternatively, since the pause operation is useful for enabling the viewer to resume viewing a television program after an interruption in the viewing experience without loss of continuity, the pause operation can be performed by recording the incoming television data to mass storage device 144 of FIG. 2 while continuing to display the live broadcast of the television program on display device of 114 of FIG. 1. This alternative technique for pausing the display of the television program is useful so long as there is some mechanism for reverting to the “paused” version of the television program recorded on mass storage device 144 when the viewer wishes to resume the program after the interruption of the viewing experience is completed. Thus, in view of the foregoing, the images, or lack thereof, displayed on the display device 114 during the pause operation is not critical to the invention.

In response to detecting a second event, computing device 112 resumes the display of the television program in a time-shifted manner. In this way, the viewer can resume viewing the paused version of the television program without missing the portion that would have been missed in the absence of the pause operation. The second event may be an event occurring in the environment of computing device 112 that indicates that the interruption of the viewing experience is completed and that the time-shifted television program is to be displayed.

One class of such second events include those that complement the first event that triggered the pause operation. For example, if the first event is an off-hook state of telephone 145, the second event can be an on-hook state of the telephone 145, indicating that a telephone call has been completed. If the first event is a ring signal, the second event can be an on-hook state of the telephone coupled with the absence of the ring signal. Another class of second events include those that are associated with user input received from remote control device 126 of FIG. 1 by user input interface 124 of FIG. 2 or in other ways from the viewer. Such events indicate that the viewer has affirmatively requested resumption of the display of the television program.

Computing device 112 may operate in a Video-On-Demand (“VOD”) environment, for example, where multimedia transport system 160 includes a VOD server and sends VOD content to computing device 112. In such embodiments, after detecting an event or evaluating a set of rules associated with the detection of an event, computing device 112 sends a signal to components of multimedia transport system 160. In response to receiving the signal from computing device 112, multimedia transport system 160 performs an operation on media content being sent to computing device 112. Thus, in cases where the output of media content is controlled at a remote server, such as the VOD server, the remote server can pause or otherwise perform an operation on the output of the content in response to an event that is local with respect to the computing device. In other embodiments, computing device 112 may notify components of multimedia transport system 160 of all detected events. In such embodiments, multimedia transport system 160 use a set of rules to determine if any operations are to be performed on media content being sent to computing device 112. Sets of rules may also be evaluated in a distributed manner, where client system 112 makes some determinations and multimedia transport system 160 makes some determinations.

In order to continue proper time-shifting, computing device 112 continues to store the television signal in which the television program is encoded after the resumption of the display of the television program after the pause. This enables the remainder of the television program to be displayed as the television program is recorded and read from the mass storage device 144 in a first-in-first-out manner. Thus, the viewer can view the television program in its entirety even though the display was paused for some amount of time.

As described above, the interruption engines of the invention detect the occurrence of an event that is designated as one that indicates that the display of a television program is to be interrupted. The interruption engine may be embodied in a single device or may be implemented in a distributed environment. For example, the interruption engine may be implemented solely in computing device 112, shared between the components of client system 110, or even shared between computing device 112 and multimedia transport system 160.

The interruption engine can be a simple as a single module that detects a single event, such as a ring signal associated with an incoming telephone call, in response to which the interruption engine pauses the display of a television program. Interruption engines can be either user-customizable to some degree or have fixed settings that cannot be customized by the user.

A user-customizable interruption engine can be customized by the user so as to designate the events that are to result in the execution of the interruption operation, to define the nature of the interruption operation, or both. For example, such interruption engines can include a registration mechanism with a user interface that enables the user to identify types of events that are to be detected and the components in the environment of the computing device 112 that are to detect events. In addition, the user interface can enable the user to select an interruption operation that is to be executed and whether or not a user may override the action.

In addition to performing the interruption operation, the interruption engine may cause a message to be displayed on the display device. Such messages can be explanatory in nature such that the viewer understands why the display of the television program has been displayed when, for example, the telephone rings. Alternatively, in the case of an incoming telephone call, the message can include caller ID data associated with the incoming telephone call. In general, messages may indicate the cause of an interruption and the response taken by the interruption engine.

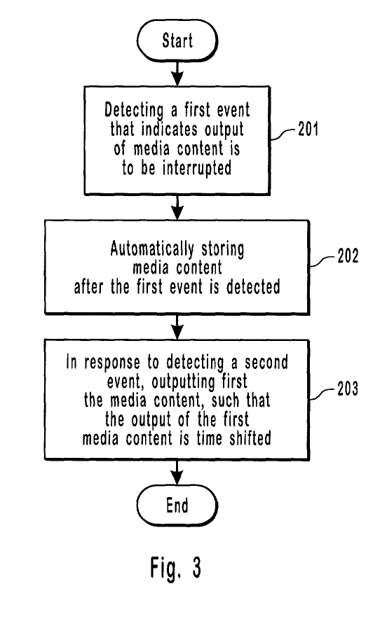

The flow chart in FIG. 3 summarizes one method according to the invention for automatically pausing and time-shifting the display of media content. The method begins by detecting a first event that indicates that the output of the media content is to be interrupted in act 201. As noted above, act 201 may include client system 112 of FIG. 1 detecting events on a telephone line, such as detecting a ring signal, detecting an off-hook state, detecting a call waiting signal, or other events that vary the electrical impedance or other electrical characteristics of a telephone line. For example, when telephone 145 is in the off-hook position, client system 110 can detect this as an event that indicates output of media content is to be interrupted.

If computing device 112 detects an event indicating that the output of the media content is to be interrupted, computing device 112 automatically executes the interruption operation. One such interruption operation is the pause of the output of the media content, which includes automatically storing the media content received by computing device 112 in act 202 of FIG. 3. In response to a second event that indicates that the interruption in the viewing experience of the viewer is completed, the media content that has been stored in act 202 is displayed in act 203, such that the media content is displayed in a time-shifted manner.

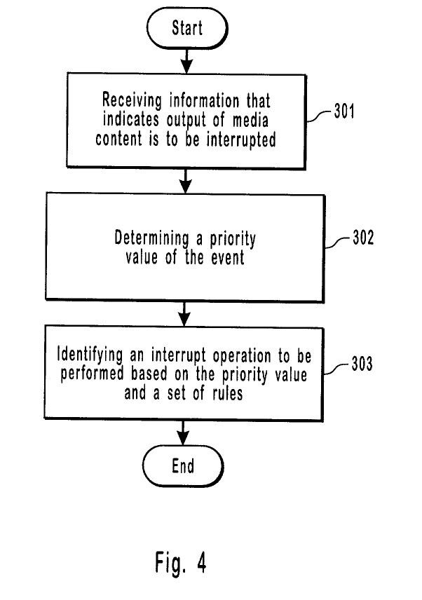

FIG. 4 is a flow diagram illustrating a method for responding to an event that indicates the output of media content is to be interrupted. In this embodiment, the interruption engine uses rules and priority values that are applied to the events. A priority value is applied to an event to describe, for example, the immediacy of the interruption in the viewer experience that is likely to be associated with the event or the likelihood that the viewer actually diverts attention from the television program to attend to the event. For example, an event associated with a ring signal may be assigned a higher priority value, while an event associated with the receipt an electronic mail message may be assigned a lower priority values. The priority values can be user-definable or default values.

After the interruption engine detects an event in act 301 of FIG. 4, the interruption engine determines the priority value that is to be applied to the event in act 302 based on information defining the priority values stored at the computing device. In act 303, the interruption engine identifies the interruption operation to be performed in response to the event based on the priority value that has been applied to the event and on a set of rules. The rules, which may be default or user-definable, specify the interrupt operations that are associated with particular priority values. For instance, the rules might specify that an event having a high priority value is to automatically result in a pause operation applied to the television program, while a low priority event is to result in the display of a message on the display device indicating to the viewer that the event has occurred and that the television program can be paused if the viewer so desires.

The priority values and the rules can come from any of a variety of sources in addition to being defined by the viewer. For instance, the rules and priority values can be imported from external computing devices or encoded in broadcast data included in the television signal. Moreover, the computing devices of the invention can be adapted to monitor historical events and the actions taken by viewers in response to such events to learn of patterns of behavior of the viewers. For instance, if it has been observed that the viewer frequently manually pauses the display of a television program immediately after a ring signal is received, the computing device can recognize this pattern and define priority values and rules that will result in the television programming being automatically paused when future ring signals are detected.

The set of rules can include exceptions. For example, a viewer may wish the display of television programming to be automatically paused when an electronic mail message is received from a first set of individuals but not when an electronic mail message is received from a second set of individuals. Such exceptions may also be learned for user behavior. For example, if a user consistently dismisses instant messages from a particular individual without responding, the interruption engine may cease activating a response mechanism when subsequent instant messages are received form the individual.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise physical storage media such as RAM, ROM, EEPROM, CD-ROM, DVD, or other optical disk storage, magnetic disk storage or other magnetic storage devices, or any other medium that can be used to carry or store desired program code means in the form of computer-executable instructions or data structures and that can be accessed by a general purpose or special purpose computer.

When information is transferred or provided over a network or another communications connection (either hardwired, wireless, or a combination of hardwired or wireless) to a computer, the computer properly views the connection as a computer-readable medium. Thus, such a connection is also properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

The invention can also be described in the general context of computer-executable instructions, such as program modules, being executed by set-top boxes or other computing devices. Generally, program modules include routines, programs, objects, components, data structures, etc. that perform particular tasks or implement particular abstract data types. The sequence of instructions implemented in a particular data structure or program module represents examples of corresponding acts for implementing the functions or steps described herein.

Computing devices that can be adapted to perform the methods of the invention include general-purpose or special purpose computers, set-top boxes, or other consumer electronic devices, such as digital video recorders, video cassette recorders, video game systems, stereo systems, televisions or monitors with data processing capabilities, cable television boxes, digital satellite system receivers, digital video broadcasting systems, digital versatile disc systems, Internet terminals, personal digital assistants and other devices capable of processing data as described herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes, which come within the meaning and range of equivalency of the claims, are to be embraced within their scope.

What is claimed is:

1. In a computing device having an associated output device, a method for automatically executing an interruption operation on media content in response to an event, comprising the acts of:
as media content is obtained and output by the output device, detecting a first event indicating that the output of the media content is to be modified; and
in response to detecting the first event, automatically executing an operation on the media content such that the output of the media content is modified and can be later restored without loss of continuity of the media output.

2. The method as recited in claim 1, wherein the act of detecting the first event comprises the act of detecting a ring signal on a telephone line.

3. The method as recited in claim 1, wherein the act of detecting the first event comprises the act of detecting an off-hook condition of a telephone.

4. The method as recited in claim 3, wherein the act of detecting an off-hook condition of a telephone comprises the act of testing the impedance of a telephone line associated with the telephone.

5. The method as recited in claim 1, wherein the act of detecting the first event comprises the act of detecting a call waiting signal on a telephone line.

6. The method as recited in claim 1, wherein the act of detecting the first event comprises the act of detecting receipt of an electronic message.

7. The method as recited in claim 1, wherein the act of detecting the first event comprises the act of detecting a signal from a device associated with a home network.

8. The method as recited in claim 1, wherein the act of detecting the first event comprises the act of detecting a signal from a motion sensor.

9. The method as recited in claim 1, wherein the act of detecting the first event comprises the act of detecting a signal from a personal transmitter.

10. The method as recited in claim 1, wherein detecting a first event indicating that the output of the media content is to be modified comprises detecting a first event indicating that the output of media content is to be interrupted.

11. The method as recited in claim 10, wherein:
the media content comprises a television program; and
the operation comprises a pause operation performed on the television program.

12. The method as recited in claim 1, wherein the act of detecting a first event indicating that the output of the media content is to be modified comprises the act of, as television programming is received from a video on demand server and output by the output device, detecting a first event indicating that the output of the television programming is to be interrupted.

13. The method as recited in claim 12, wherein the act of detecting a first event indicating that the output of the television programming is to be interrupted comprises the act of transmitting a signal from the computing device to the video on demand server indicating that the output of the television programming is to be interrupted by the video on demand server.

14. The method as recited in claim 1, wherein the act of automatically executing an operation on the media content comprises the act of automatically executing an operation on the media content such that the output of the media content is interrupted and can be later resumed without loss of continuity of the media output.

15. The method as recited in claim 14, further comprising the act of, in response to a second event, resuming the output of the media content.

16. The method as recited in claim 14, wherein:
the media content comprises a television program;
the operation comprises a pause operation performed on the television program; and
output of the television program is resumed in response to the second event such that, from the standpoint of a viewer, it appears as if a live broadcast of the television program had been paused.

17. The method as recited in claim 1, further comprising the act of displaying a message associated with detection of the first event.

18. The method as recited in claim 17, wherein the act of displaying a message associated with detection of the first event comprises the act of displaying caller ID data associated with an incoming telephone call.

19. In a computing device having an associated display device and an associated storage device, a method of automatically pausing the display of a television program in response to an event in the environment of the computing device, comprising the acts of:
as the television program is obtained and displayed on the display device, detecting a first event that has been designated to indicate that the display of the television program is to be interrupted;
in response to the detected event, automatically storing a television signal in which the television is encoded on the storage device so as to pause the display of the television program; and
in response to a second event, resuming display of the television signal by displaying the television signal that has been stored on the storage device.

20. The method as recited in claim 19, wherein the act of detecting the first event comprises the act of detecting a ring signal on a telephone line.

21. The method as recited in claim 19, wherein the act of detecting the first event comprises the act of detecting an off-hook condition of a telephone.

22. The method as recited in claim 21, wherein the off-hook condition is detected immediately after a ring signal on a telephone line associated with the telephone.

23. The method as recited in claim 19, wherein the act of detecting the first event comprises the act of detecting receipt of an electronic message.

24. The method as recited in claim 19, wherein the act of detecting the first event comprises the act of detecting a signal from a device associated with a home network.

25. In a computing device having an interruption engine and an associated output device, a method for automatically executing an interruption operation on media content in response to an event, comprising the acts of:
as media content is received and output by the output device, detecting an event in the environment of the computing device;
identifying a priority value to be assigned to the event based on priority information stored at the computing device;
applying a rule of a set of rules to the priority value assigned to the event to identify an interruption operation; and
automatically executing the interruption operation on the media content.

26. The method as recited in claim 25, wherein the act of detecting the event comprises the act of determining that a telephone call is being made or received.

27. The method as recited in claim 25, wherein the act of detecting the event comprises the act of detecting the receipt of an electronic message.

28. The method as recited in claim 25, wherein the act of detecting the event comprises the act of receiving information via an input mechanism that was established for interrupt sources to inform the interruption engine that the output of media content is to be interrupted.

29. The method as recited in claim 25, further comprising the act of receiving the set of rules in broadcast data en coded in a television signal.

30. The method as recited in claim 25, further comprising the act of receiving data that was registered with the interruption engine by a user, wherein the data defines the set of rules.

31. The method as recited in claim 25, wherein the interruption operation is such that the output of the media content is paused.

32. The method as recited in claim 25, further comprising the act of the interruption engine learning the behavior of a viewer associated with the computing device so as to generate the information on which the priority value to be assigned to the event is based.

33. The method as recited in claim 25, further comprising the act of the interruption engine learning the behavior of a viewer associated with the computing device so as to generate the rule of the set of rules.

34. The method as recited in claim 25, wherein the act of applying a rule of a set of rules to the priority value comprises the act of further applying an exception to the rule.

35. The method as recited in claim 25, wherein the act of applying a rule of a set of rules to the priority value comprises a video on demand server applying a rule of a set of rules to the priority value.

36. The method as recited in claim 25, wherein the interruption operation comprises pausing the output of the media content.

37. A computer program product for implementing, in a computing device having an associated output device, a method for automatically executing an interruption operation on media content in response to an event, the computer program product comprising:
a computer-readable medium carrying computer-executable instructions that, when executed at the computing device, cause the computing device to perform the method, including the acts of:
as media content is obtained and output by the output device, detecting a first event indicating that the output of the media content is to be modified; and
in response to detecting the first event, automatically executing an operation on the media content such that the output of the media content is modified and can be later restored without loss of continuity of the media output.

38. A computer program product for implementing, in a computing device having an associated display device and an associated storage device, a method of automatically pausing the display of a television program in response to an event in the environment of the computing device, the computer program product comprising:
a computer-readable medium carrying computer-executable instructions, that when executed at the computing device, cause the interruption engine to perform the method, including the acts of:
as the television program is received and displayed on the display device, detecting a first event that has been designated to indicate that the display of the television program is to be interrupted;
in response to the detected event, automatically storing a television signal in which the television is encoded on the storage device so as to pause the display of the television program; and
in response to a second event, resuming display of the television signal by displaying the television signal that has been stored on the storage device.
